(19) United States
(12) Patent Application Publication
(10) Pub. No.: US 2019/0143609 A1
(43) Pub. Date: May 16, 2019

(54) ANTI-ABRASION COATING METHOD AND APPARATUS

(71) Applicant: AVERY DENNISON RETAIL INFORMATION SERVICES, LLC, Mentor, OH (US)

(72) Inventor: William D. BERNARD, Altadena, CA (US)

(21) Appl. No.: 16/193,061

(22) Filed: Nov. 16, 2018

Related U.S. Application Data
(60) Provisional application No. 62/587,301, filed on Nov. 16, 2017.

(51) Int. Cl. B29C 65/00; B29C 65/02

(52) U.S. Cl. CPC B29C 66/729; B29L 2031/48; B29C 65/02

(57) ABSTRACT

A protective device for enhancing the durability of a substrate, and a method of applying the protective device to the substrate is disclosed herein. In one exemplary embodiment, the protective device may be comprised of a barrier or bonding component and a transfer component removably attached to the bonding component. When applied to an article via heat and/or pressure, such as an article of clothing, the protective device of the present invention can provide anti-abrasion and/or enhanced wear capabilities in desired areas. The protective device could be applied to those portions of the article, such as the knee areas of pants or elbow areas of shirts, to reduce or slow down the wear and tear typically associated with their use and extend their useful life.

### CROSS-REFERENCE TO RELATED APPLICATION

The present application claims priority to and the benefit of U.S. Provisional Application No. 62/587,301 filed on Nov. 16, 2017, which is incorporated herein by reference in its entirety.

### BACKGROUND

Clothing, safety attire and other articles that are worn, such as shirts, pants, uniforms, personal protective equipment, and the like, are susceptible to wear and tear from regular use. Further, different clothing materials wear faster or more easily than others, and certain areas of clothing are more prone to wear. For example, clothing worn about a wearer's knees, elbows, buttocks, crotch, wrists (cuffs), and shoulders often wear out, fail, rip, or otherwise deteriorate faster than other areas along the article of clothing. Moreover, clothing worn during the course of performing physical labor, participating in a sporting or outdoor activity, repeated work related activities and/or the like oftentimes also wear faster in the above referenced or other areas where the clothing is in regular or constant contact with a surface.

Traditional solutions to prevent or decrease the wear and tear or destruction of clothing include sewing or otherwise fastening patches or durable materials to heavy wear areas of the clothing. However, such solutions often detract from the aesthetic appearance of the clothing, or are not suitable to be worn in many environments or conditions which result in high amounts of clothing wear or fatigue. Additionally, these solutions are subject to wearing out on their own, becoming dislodged, and/or otherwise not functioning properly. Further, the placement of such solutions is often limited to the exterior portions of the clothing article so as to not interfere with the comfort of the individual wearing the same or to comply with certain manufacturing requirements.

Therefore, there is a long felt need in the art for a solution that provides enhanced durability to articles that are prone to wear, such as clothing, and that does not otherwise detract from the aesthetic appearance of the article. The present invention discloses a protective device for a clothing article, such as a heat transfer label, that reduces the degradation of the clothing article in those areas that are typically prone to excessive wear. The present invention also discloses a method of applying the protective device to an article of clothing, as well as to other articles that would benefit from anti-abrasion or excessive wear reduction characteristics.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a protective device, substance or coating, such as a heat transfer label or other polymeric material, for enhancing the durability of those portions of an article of clothing that are prone to wear or premature degradation, without detracting from the aesthetical appearance of the article. The present invention also discloses a method of applying the protective device or coating to the article of clothing, or any other article that may benefit anti-abrasion or excessive wear reduction characteristics.

In one exemplary embodiment, the protective device or coating can be applied to portions of an article of clothing to provide anti-abrasion or enhanced wear capabilities along those specific portions of the article that are the most prone to wear and tear. For example, the protective device or coating could be provided in areas such as the knee areas of pants, or elbow areas of shirts. The protective device applied to these areas can provide properties to the article of clothing that reduce or prevent wear and tear, for example, by forming a protective barrier outside of the fabric of the article of clothing or infusing the same into the clothing fabric. As a result, the clothing with the protective device may have enhanced durability and a longer useful life, both of which are desirable.

In accordance with one embodiment of the present invention, the protective device or coating comprises a bonding or barrier component. The barrier component may be bondable to a substrate or fabric, such as an article of clothing, to enhance the durability of the substrate where bonded to the barrier component. More specifically, the barrier component may either bond to the surface of the substrate, or it may integrate or infuse into the substrate to form a protective barrier to wear.

According to another exemplary embodiment of the present invention, the protective device may comprise both a bonding or barrier component and a transfer component. The bonding component is bondable to a substrate, such as clothing fabric, to enhance the durability of the substrate and reduce or slow its degradation when subjected to repeated wear and tear and/or abrasive materials. Further, the transfer component may be removably attached to the barrier component to protect the same until the barrier component is ready to be attached or infused into the substrate or fabric.

According to yet another exemplary embodiment, a method of applying the protective device of the present invention to a substrate is disclosed. More specifically, and by way of example, the backing of the transfer component may be removed from the protective device to expose the bonding or barrier component. The barrier component may then be positioned adjacent to the area of the substrate, such as the fabric of an article of clothing, where reinforcement and/or enhanced durability is desired. Finally, heat and/or pressure may then be applied to the barrier component to attach or integrate the barrier component with the substrate, such as the fabric of an article of clothing. More specifically, the barrier component may attach itself to the exterior of the fabric, or infuse itself into said fabric to create a bond therewith. The barrier component may further comprise an adhesive of ink layer or coating to further aid in the attaching of the barrier component to the article.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 illustrates a front perspective view of a plurality of protective devices attached to an article of clothing, namely a pair of pants, in accordance with the disclosed architecture.

FIG. 2 illustrates a front perspective view of the plurality of protective devices attached to a second article of clothing, namely a shirt, in accordance with the disclosed architecture.

FIG. 3 illustrates a perspective view of one potential embodiment of a protective device of the present invention in accordance with the disclosed architecture.

FIG. 4 illustrates a perspective view of an alternative embodiment of a protective device of the present invention in accordance with the disclosed architecture.

FIG. 5 illustrates a perspective view of yet another alternative embodiment of a protective device of the present invention in accordance with the disclosed architecture.

FIG. 6 illustrates a flow chart of one embodiment of the method of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a protective device for enhancing or improving the durability of a substrate, such as an article of clothing with areas thereof that are prone to premature degradation from excessive wear. According to an exemplary embodiment, and referring generally to the Figures, protective devices for use with articles of clothing and methods for forming articles of clothing with protective devices may be shown and described. While the present specification relates to articles of clothing, the present specification is not limited to such. Stated differently, the protective devices of the present invention and their related methods may be used with any substrate where material fatigue or increased wear is likely. Further, the articles of clothing may include one or more protective devices that are applied to desired areas of the clothing, and which can provide enhanced durability and life to the article of clothing.

The protective devices of the present invention may act as a reinforcing element, a barrier, or an anti-abrasion agent that covers the applied areas, or may be infused into the fabric of the clothing to decrease wear, and otherwise extend the useful life of high wear portions of the fabric without detracting from the aesthetic appeal of the article. The protective devices can be utilized on a variety of substrates or materials for a variety of articles, such as clothing, as well as other fabric items which incur excessive wear. For example, the protective device described herein could be utilized on canvas bags, backpacks, computer cases, garment bags, suitcases, shoes, gloves, personal protective equipment, apparel accessories and the like.

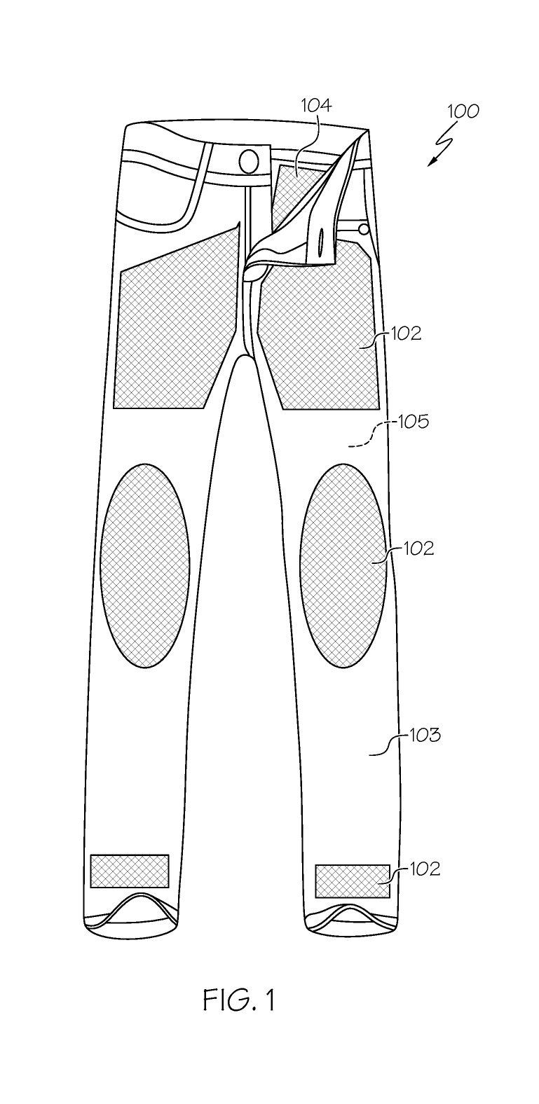

Referring now to the Figures, FIG. 1 illustrates a front perspective view of a plurality of protective devices 102 attached to an article 100 in accordance with the disclosed architecture. Article 100 can be an article of clothing as shown in FIG. 1, for example a pair of pants, but can also be any other article that would benefit from added protection against wear, such as canvas bags, backpacks, computer cases, garment bags, suitcases, shoes, gloves, personal protective equipment, apparel accessories, and the like. The pair of pants 100 depicted in FIG. 1, may be any type of pants, for example, denim jeans, cargo pants, business slacks, personal protective equipment, etc. The pants 100 may be formed and shaped in traditional or known manners.

One or more protective devices 102 of the present invention, which are more fully described below, may be applied to the exterior or interior portions of article 100 depending upon user preference. For example, FIG. 1 depicts a plurality of protective devices 102 applied on the exterior portion 103 of the pants 100. More specifically, the plurality of protective devices 102 may be applied to those areas 104 of the pants 100 known for incurring high amounts of wear or that are prone to premature failure or degradation. For example, the plurality of protective devices 102 can be applied to the knee areas, the thigh/crotch areas, for example when the pants are used for equestrian related activities, and the cuff areas of the pants 100. Although the plurality of protective devices 102 are only shown on the exterior portion 103 of the pants 100 in FIG. 1, it may be appreciated by one of ordinary skill in the art that protective devices 102 may also be deployed on the interior portions 105 of pants 100 in combination with those applied to the exterior surfaces 103, or as an alternative thereto.

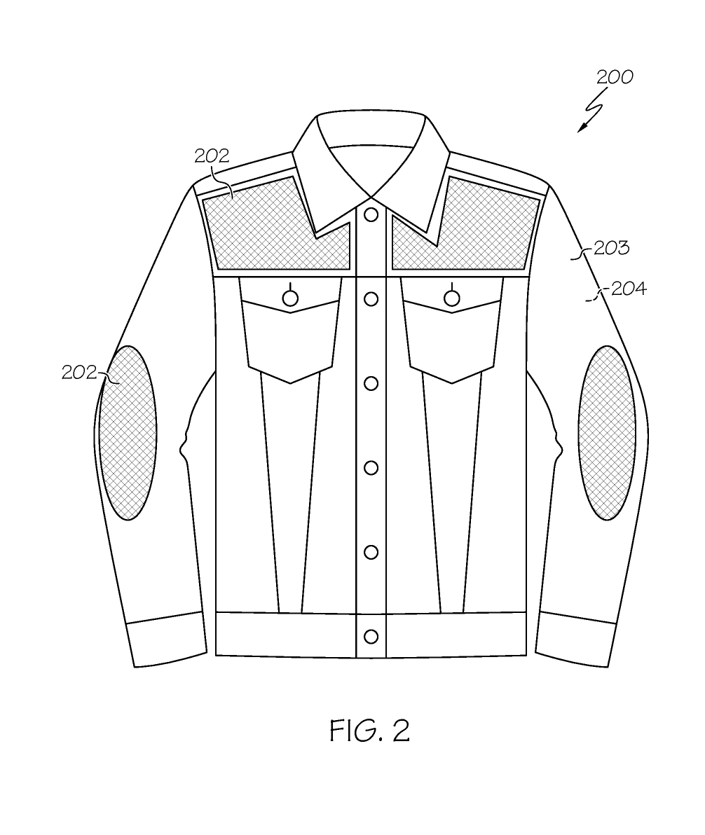

Similar to FIG. 1, FIG. 2 illustrates a front perspective view of the plurality of protective devices 202 attached to a second article of clothing 202, namely a shirt, in accordance with the disclosed architecture. More specifically, one or more protective devices 202 of the present invention may be applied to the exterior or interior portions of shirt 200. For example, FIG. 2 depicts a plurality of protective devices 202 applied on the exterior portion 203 of shirt 200. The plurality of protective devices 202 may be applied to those areas of the shirt 200 known for incurring high amounts of wear or that are prone to premature failure. For example, the plurality of protective devices 202 can be applied to the elbow area, armpit areas and/or the collar areas of shirt 200.

Although the plurality of protective devices 202 are only shown on the exterior portion 203 of the shirt 200 in FIG. 2, it may be appreciated by one of ordinary skill in the art that protective devices 202 may also be deployed on the interior portion 204 of shirt 200 in combination with those applied to the exterior surfaces 203, or as an alternative thereto.

When the plurality of protective devices 102, 202 are applied to articles of clothing or other fabric articles, the plurality of protective devices 102, 202 may form a barrier on the fabric of the article. This barrier may act similarly to a traditional sewn-on patch, but may also be more integrally formed with the fabric and provide enhanced durability, improved appearance, and generally reduce wear. For example, knee areas of pants 100 are commonly known to wear out due to the general walking motion of wearers, kneeling on the ground or other various surfaces when performing activities, or otherwise rubbing or bumping against exterior objects. Traditionally, such activity results in the knee areas of pants 100 fatiguing, tearing, or otherwise wearing out faster than, for example, lesser used portions of the pants such as the shin areas. Therefore, incorporating the plurality of protective devices 102 with the pants 100 will reduce the wear and fatigue on the applied areas, thereby resulting in pants 100 with a longer useful life and greater functionality.

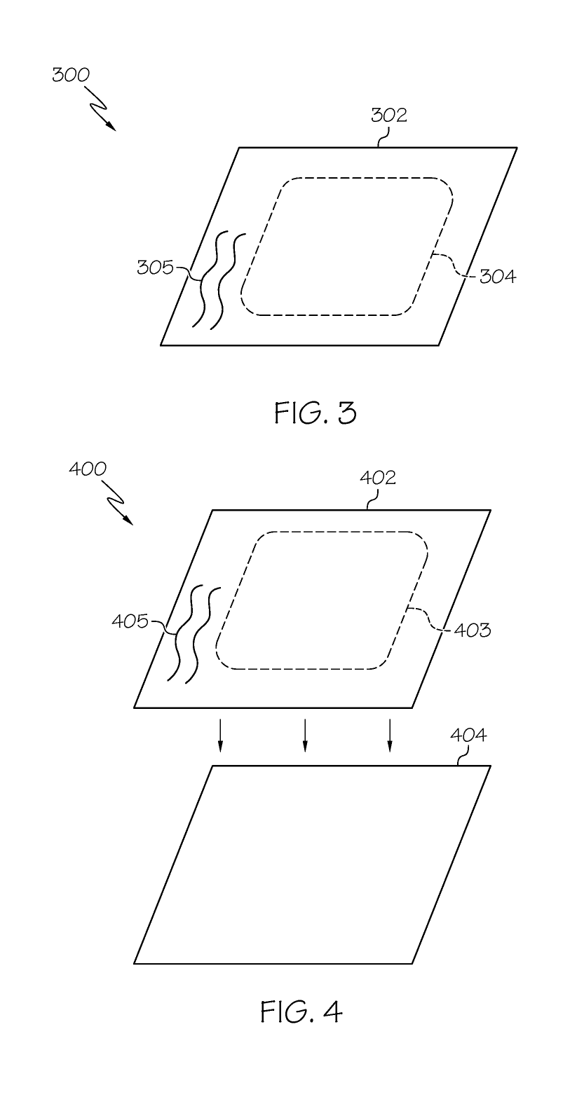

FIG. 3 illustrates a perspective view of one potential embodiment of protective device 300 of the present invention in accordance with the disclosed architecture. Protective device 300 may be the same as protective devices 102, 202 depicted in FIGS. 1 and 2, and is preferably comprised of a barrier component 302 bondable to at least a portion of a substrate, such as articles of clothing 100, 200 for enhancing their durability. The barrier component 302 is typically comprised of a polyethylene, polypropylene, polystyrene or polyvinylchloride, though other materials are also contemplated. Other exemplary heat transfer labels include that which is shown and disclosed in U.S. Pat. Nos. 7,906,189, 8,012,557, 8,247,056, 8,647,740, 9,132,931, 9,499,937, 9,701,153 and 10,035,368 all of which are commonly assigned with the applicant of the present invention. Further, barrier component 302 is typically activated using heat, pressure, or both, but may further comprise an adhesive 304, such as a polyamide, phenoxy or polyester adhesive, positioned thereon that enables barrier component 302 to bond to the surface of the substrate or that integrates with the substrate to form a barrier that can resist or reduce wear to the article 100, and potentially other items, such as liquids. Adhesive 304 is also typically activated using heat, pressure, or both.

As previously stated, in one embodiment, the protective device 300 may comprise a heat transfer device, such as a hot paper transfer that is applied to a textile or fabric with heat and/or pressure. The protective device 300 may be such that it does not utilize any form of special coated paper, adhesive glue, or powders in the application process. Instead, the barrier component 302 may comprise an ink 305 throughout the barrier component 300 or otherwise in desired areas. Ink 305 may be comprised of one or more conventional heat transfer label inks, such as polyester inks, polyester/vinyl inks, polyamide inks and/or acrylic inks.

Upon application of heat and/or pressure to the protective device 300, the ink 305 melts. The melting of the ink 305 causes it to bond with the underlying fabric and, in some exemplary embodiments, to form a patch-like area of high durability, such as shown in FIGS. 1 and 2. Alternatively, the ink 305 may melt in such a manner so as to be infused into the fabric of article 100, 200. Such inks 305 may melt and be infused into the fabrics without bleeding into surrounding fabrics.

The barrier component 302 may be transparent or translucent when applied to the substrate of articles 100, 200. Alternatively, the barrier component 302 may be visible as desired, such as imbedded with a decorative design or other useful indicia, such as branding, garment care instructions, or artwork.

Protective device 300 can be any suitable size, shape, and configuration as is known in the art for providing ample coverage for articles 100, 200 needing protection from wear without affecting the overall concept of the invention. One of ordinary skill in the art will appreciate that the shape and size of protective device 300 as shown in FIG. 3, and protective devices 102, 202 in FIGS. 1 and 2, are for illustrative purposes only and many other shapes and sizes of protective device 300 are well within the scope of the present disclosure. Although the shape and dimensions of protective device 300 (i.e., length and width) are important design parameters for good performance, protective device 300 may be any shape or size that ensures optimal performance during use.

FIG. 4 illustrates a perspective view of an alternative embodiment of a protective device 400 of the present invention in accordance with the disclosed architecture. Protective device 400 may be the same as protective devices 102, 202 depicted in FIGS. 1 and 2, and is preferably comprised of a barrier or bonding component 402 bondable to at least a portion of a substrate, such as articles of clothing 100, 200 for enhancing their durability.

As described above, the barrier component 402 is typically comprised of a polyethylene, polypropylene, polystyrene or polyvinylchloride, though other materials are also contemplated. Further, barrier component 402 is typically activated using heat, pressure, or both, but may further comprise an adhesive 403 positioned thereon that enables barrier component 402 to bond to the surface of the substrate or that integrates with the substrate to form a barrier that can resist wear and potentially other items, such as liquids.

Adhesive 403 may include a polyamide, phenoxy or polyester adhesive, or any other suitable adhesive known in the art without affecting the overall concept of the present invention. The adhesive 403 may be positioned on barrier component 402 to enable barrier component 402 to bond to the surface of the substrate, or integrate with the substrate to form a barrier that can resist or reduce wear to the article 100, 200, and potentially other items, such as liquids. Adhesive 403 is also typically activated using heat, pressure, or both.

Protective device 400 further comprises a transfer component 404 that is removably detachable from barrier component 402. The transfer component 404 may comprise a removable backing, such as a transfer paper, a pealable film, or the like, and protects barrier component 402 and adhesive 403, if present, prior to its application to article 100, 200. For example, transfer component 404 may protect barrier component 402 from becoming dirty or from premature activation, both of which could damage protective device 100 and render the same unusable.

As described above, in one embodiment, the protective device 400 may comprise a heat transfer device, such as a hot paper transfer that is applied to a textile or fabric with heat and/or pressure. The protective device 400 may be such that it does not utilize any form of special coated paper, adhesive glue, or powders in the application process. Instead, the barrier component 402 may comprise an ink 405 throughout the barrier component 402 or otherwise in desired areas. Ink 405 may be comprised of one or more conventional heat transfer label inks, such as polyester inks, polyester/vinyl inks, polyamide inks and/or acrylic inks.

Upon application of heat and/or pressure to the protective device 400, the ink 405 melts. The melting of the ink 405 causes it to bond with the underlying fabric, in some exemplary embodiments, to form a patch-like area of high durability, such as shown in FIGS. 1 and 2. Alternatively, the ink 405 may melt in such a manner so as to be infused into the fabric of article 100, 200. Such inks 405 may melt and be infused into the fabrics without bleeding into surrounding fabrics.

Additional transfer techniques are also contemplated by the present invention. For example, in a hot-split transfer, heat is applied to the barrier component 402 and the transfer component 404 is removed before the heat dissipates. Additionally, as previously mentioned, the barrier component 402 may form a liquid resistant barrier where applied. In another embodiment, the protective device 400 may be bonded to article 100, 200 using a cold method transfer process. For example, in a cold-peal transfer, heat may be initially applied, but the transfer component 404 is not removed until the protective device 400 has cooled.

Further, the barrier component 402 may be transparent or translucent when applied to the substrate of article 100, 200. Alternatively, the barrier component 402 may be visible as desired, such as imbedded with a decorative design or other useful indicia, such as branding, garment care instructions, or artwork.

Protective device 400 can be any suitable size, shape, and configuration as is known in the art for providing ample coverage for articles 100, 200 needing protection from wear without affecting the overall concept of the invention. One of ordinary skill in the art will appreciate that the shape and size of protective device 400 as shown in FIG. 4, and protective devices 102, 202 in FIGS. 1 and 2, are for illustrative purposes only and many other shapes and sizes of protective device 400 are well within the scope of the present disclosure. Although the shape and dimensions of protective device 400 (i.e., length and width) are important design parameters for good performance, protective device 400 may be any shape or size that ensures optimal performance during use.

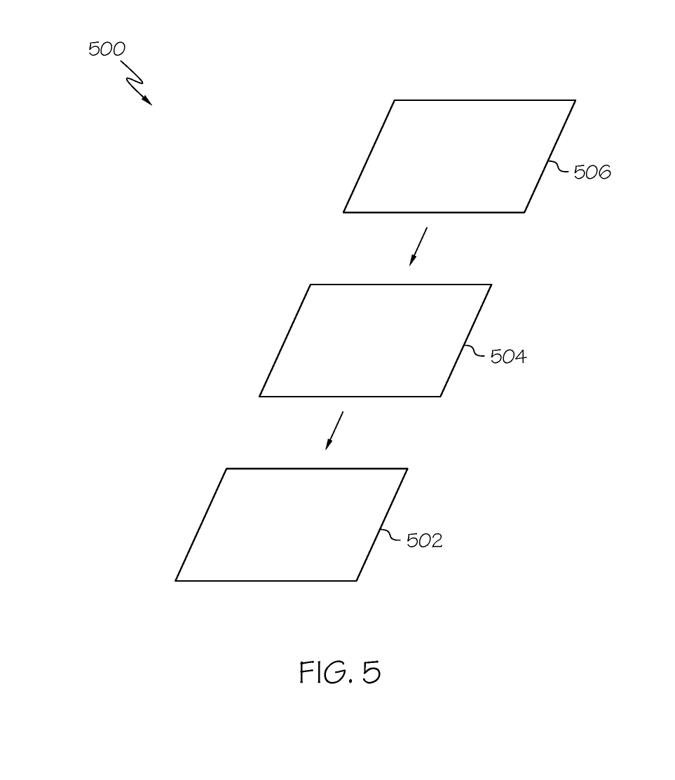

Alternatively, as illustrated in FIG. 5, a protective device 500 may be in the form of a heat transfer label comprised of a paper sheet or web 502, a wax release layer 504 affixed to the paper sheet 502, and a barrier component 506 comprised of an ink design layer printed on the wax release layer 504. In the heat-transfer labelling process, the label-carrying web 502 is subjected to heat, and the protective device 500 is pressed onto article 100, 200 with the barrier component 506 making direct contact with the article 100, 200.

As the paper sheet 502 is subjected to heat, the wax release layer 504 begins to melt. This enables the paper sheet 502 to be released from the barrier component 506, with a portion of the wax release layer 504 being transferred with the barrier component 506 onto the article 100, 200 and with a portion of the wax release layer 504 remaining with the paper sheet 502. After transfer of the barrier component 506 to the article 100, 200, the paper sheet 502 is immediately removed, leaving the barrier component 506 with the design firmly affixed to the article 100, 200 and the wax transferred therewith exposed to the environment. The wax release layer 504 is thus intended to serve two purposes: (1) to provide release of the barrier component 506 from the paper web 502 upon application of heat to the paper web 502 and (2) to form a further protective layer over the transferred barrier component 506.

Additionally, in some such embodiments of the present invention, the ink for the protective device may be color matched to the underlying fabric that receives the protective device, for example blue ink on the protective device that matches the blue denim of a pair of jeans. In such embodiments, the protective device may be coupled to or infused into the fabric in such a manner as to be substantially transparent or otherwise unseen on regular visual inspection.

In other exemplary embodiments, the protective devices may use ink or inks of a certain color that contrast with the color of the underlying fabrics so as to create visual distinctions between the heat transfer and fabric, designate spots of enhanced durability, provide designs, or for any other desired reason.

In addition to the various inks referenced above, the ink may also be a plastisol, such as a suspension of PVC or other non-water soluble polymer particles in a liquid plasticizer that is capable of flowing like a liquid when heated. These types of ink material are ideal for screen printing application, and cure with heat to form a coating bonded to the surface of the fabric. Stabilizer additives may also be added to resist degradation from light, chemical, or mechanical stress. Alternatively, acrysol water-based inks may be employed when the application benefits from the ink integrating directly into the substrate to form an integrated barrier.

The protective devices 102, 202, 300, 400, 500, whether infused into the fabric or coupled to the outside of the applied-to fabric, will then create an anti-abrasion area where the protective devices are employed that are high strength and decrease wear and tear, such as ripping or the formation of holes, for clothing with superior longevity than that of the fabric alone. Further, depending on the particular application, the protective devices can provide varying levels of liquid resistance. Additionally, the formation of the protective devices described herein may not negatively impact the flexibility, comfort, wash-ability, appearance, and general utility of the clothing articles (or any other articles) to which they are applied. Further, the protective devices may be applied in a cost-effective manner that does not significantly increase the cost of the clothing articles onto which the heat transfers are applied. Additionally, in other exemplary embodiments, the protective devices may be applied to articles of clothing after their manufacture, for example on an individual basis.

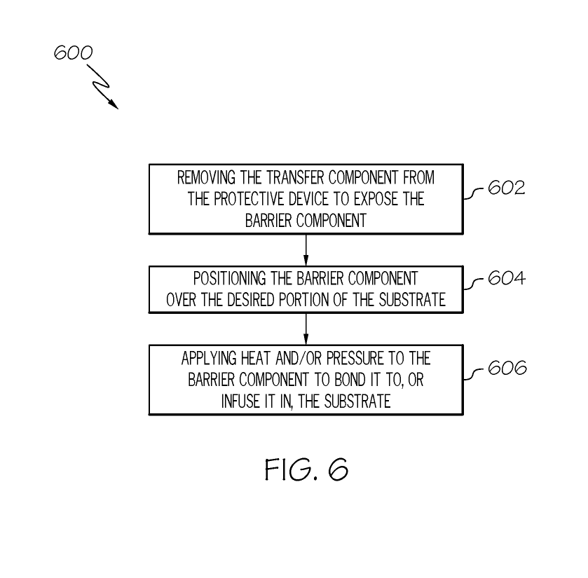

Having described a number of potential alternative embodiments of the protective device of the present invention, a method of its application to an article, such as clothing 100, 200, will now be described in general terms. More particularly, FIG. 6 illustrates a flow chart of one embodiment of the method of the present invention 600 in accordance with the disclosed architecture. At 602, a backing or transfer component is removed from the barrier component of a protective device to prepare the same for application to a desired portion of an article, such as clothing 100, 200. At 604, the barrier component is positioned over the desired portion of article 100, 200, such as a portion of the article that is more prone to wear and tear than other portions of the article. At 606, heat and/or pressure may be applied to the barrier component to cause it, or the adhesive positioned thereon, to adhere to the surface of the article or infuse into the fabric of the article. In this manner, the protective device of the present invention can be used to protect those articles, or portions thereon, that are particularly prone to wear and tear and extend the useful like of the same. An alternate method for practicing the present invention is to print successive layers of the heat transfer label directly onto the areas of the garment. By practicing the invention in this manner, replacement patches can be quickly and easily created to fix the area of the apparel which may have been subjected to additional wear.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective device for enhancing durability of a substrate, comprising:
a barrier component; wherein the barrier component is bondable to at least a portion of the substrate to resist damage from wear.

2. The protective device of claim 1, wherein the barrier component bonds to a surface of the substrate.

3. The protective device of claim 1, wherein the barrier component integrates with the substrate.

4. The protective device of claim 1, wherein the barrier component is substantially transparent when bonded to the substrate.

5. The protective device of claim 1, wherein the barrier component is liquid resistant.

6. The protective device of claim 1, wherein the barrier component is activated by at least one of heat or pressure.

7. The protective device of claim 1, wherein the barrier component comprises an ink.

8. The protective device of claim 1 further comprising a transfer component removably detachable from the barrier component.

9. The protective device of claim 8, wherein the transfer component is a removable backing.

10. A heat transfer device for enhancing durability of a substrate, comprising
a bonding component; and
a transfer component, wherein the bonding component bonds with the substrate to resist damage to the substrate.

11. The heat transfer device of claim 10, wherein the bonding component bonds to a surface of the substrate.

12. The heat transfer device of claim 10, wherein the bonding component integrates with the substrate.

13. The heat transfer device of claim 10, wherein the bonding component comprises an ink.

14. The heat transfer device of claim 10, wherein the bonding component is bonded to the substrate using heat or pressure.

15. The heat transfer device of claim 10, wherein the transfer component is a removable backing.

16. The heat transfer device of claim 10, wherein the bonding component is liquid resistant.

17. The heat transfer device of claim 10, wherein the heat transfer device is a hot paper transfer.

18. A method of applying a protective device to a substrate comprising the steps of:
removing a backing component of the protective device to expose a bonding component;
positioning the bonding component adjacent to a portion of the substrate; and
bonding the bonding component to the substrate.

19. The method of claim 18, wherein the bonding of the bonding component to the substrate is accomplished by the application of at least one of heat or pressure to the bonding component.

20. The method of claim 19, wherein the bonding component is an ink.
